(19) United States
(12) Patent Application Publication
(10) Pub. No.: US 2006/0146448 A1
(43) Pub. Date: Jul. 6, 2006

(54) Method and apparatus for an actuator arm block including a crash stop stub in a hard disk drive

(76) Inventors: Gregory Tran, Santa Clara, CA (US); Tho Pham, San Jose, CA (US); Shiao-Hua Chen, Palo Alto, CA (US); Joseph Chang, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/029,111

(22) Filed: Dec. 30, 2004

(51) Int. Cl. G11B 5/54

(52) U.S. Cl. 360/265.1

(57) ABSTRACT

The invention includes an actuator arm block for use in an actuator assembly within a hard disk drive, which includes a crash stop stub on a middle actuator arm to contact a crash stop rubber in the hard disk drive. The crash stop stub is preferably aligned with a crash stop rubber to stop the actuator assembly from swinging away from a rotating disk surface in the hard disk drive. A flexible printed circuit bracket preferably includes the crash stop rubber may further include an air block. The actuator arm block coupled with a voice coil, an actuator assembly and hard disk drive including the actuator arm block. The methods of manufacturing the actuator arm block coupled with a voice coil, an actuator assembly and hard disk drive, as well as process products.

### TECHNICAL FIELD

The invention relates to the operation of hard disk drives. More particularly, the invention relates to an actuator arm block in the actuator assembly of a hard disk drive that supports a crash stop and may facilitate an air block reducing air flow turbulence at the read-write head(s) of the actuator assembly when the disk(s) rotate.

### BACKGROUND OF THE INVENTION

Prior art hard disk drives have a problem with stopping the read-write head(s) of an actuator assembly from swinging violently away from the disk spindle, possibly crashing and damaging the read-write heads. Mechanical shocks and vibrations acting upon a hard disk drive may cause such swinging. Certain hard disk drive applications, such as hand held computers, notebook computers, and MP3 players are especially susceptible to these shocks and vibrations. The prior art addresses this problem by using at least one separate part for the outside diameter crash stop, known herein as a crash stop stub. This part, or parts, adds to the cost of producing the hard disk drive. What is needed is a cost effective mechanism that provides the outside diameter crash stop while reducing the parts count.

These prior art hard disk drives also have a problem with air turbulence affecting the read-write heads. The air turbulence often displaces the read-write heads, adversely affecting the ability of the hard disk drive to follow a track. For example, contemporary hard disk drives often have track densities around 20,000 tracks per inch, or more. As the track densities increase, the need to reduce any read-write head positional deviations also increases. Reducing the airflow at the read-write heads reduces turbulence, and read-write head positional variations. What is needed are new cost effective ways to reduce the air flow near the read-write heads.

### SUMMARY OF THE INVENTION

The invention relates to the operation of hard disk drives. More particularly, the invention relates to an actuator arm block in the actuator assembly of a hard disk drive that includes a crash stop and may facilitate an air block reducing air flow turbulence at the read-write head(s) of the actuator assembly when the disk(s) rotate.

The invention includes an actuator arm block for use in an actuator assembly within a hard disk drive, which includes a crash stop stub on a middle actuator arm to contact a crash stop rubber in the hard disk drive. The crash stop stub is preferably aligned with a crash stop rubber to stop the actuator assembly from swinging away from a rotating disk surface in the hard disk drive. The actuator arm block may include exactly one actuator arm, as the middle actuator arm, or it may include more than one actuator arm. The middle actuator arm will refer herein to an actuator arm of the actuator arm block located close to the middle of the actuator arm block.

The invention may further preferably include a flexible printed circuit bracket including the crash stop rubber. The flexible printed circuit bracket may further preferably include an air block for directing the air flow from one or more rotating disks away from at least one head gimbal assembly attached to the actuator arm block.

The invention includes the actuator arm block coupled with a voice coil, an actuator assembly and hard disk drive including the actuator arm block, as well as methods of manufacturing them. The actuator arm block coupled with the voice coil, the actuator assembly and the hard disk drive are also products of the invention's manufacturing methods.

### BRIEF DESCRIPTION OF THE DRAWINGS

FIG. 1A shows a hard disk drive including an actuator arm block, that contains a crash stop stub on a middle actuator arm aligned to couple with a crash stop rubber;

FIG. 1B shows the hard disk drive including an actuator assembly with an alternative flexible printed circuit bracket containing the crash stop rubber;

FIGS. 2A and 2B show embodiments of the hard disk drive with alternative embodiments of the flexible printed circuit bracket including both an air block and the crash stop stub;

FIGS. 3A and 3B show the actuator arm block coupled with the voice coil.

### DETAILED DESCRIPTION

The invention includes an actuator arm block for use in an actuator assembly within a hard disk drive, which includes a crash stop stub on a middle actuator arm to contact a crash stop rubber in the hard disk drive. The crash stop stub is preferably aligned with a crash stop rubber to stop the actuator assembly from swinging away from a rotating disk surface in the hard disk drive. The actuator arm block may include exactly one actuator arm, as the middle actuator arm, or it may include more than one actuator arm. The middle actuator arm will refer herein to an actuator arm of the actuator arm block located close to the middle of the actuator arm block.

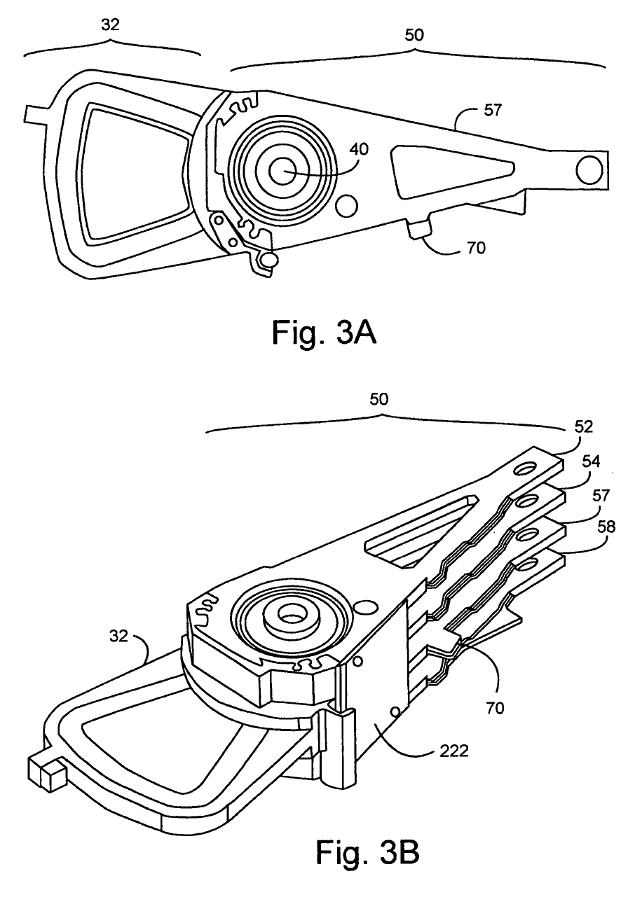

The invention includes an actuator arm block 50 shown in all the Figures, for use in an actuator assembly 200 within a hard disk drive 10. The actuator arm block includes a crash stop stub 70 on a middle actuator arm 56 aligned to contact a crash stop rubber 120 in the hard disk drive. The crash stop stub is preferably aligned with a crash stop rubber to stop the actuator assembly from swinging away from a rotating disk surface 82 in the hard disk drive. The actuator arm block may include exactly one actuator arm, as the middle actuator arm, as in FIG. 3A. The actuator arm block may include more than one actuator arm as shown in all of the other Figures. The middle actuator arm will refer herein to an actuator arm located close to the middle of the actuator arm block. An alternative embodiment to FIG. 3B may preferably include the crash stop stub on the second actuator arm 54. The invention includes the actuator arm block 50 coupled with a voice coil 32 as shown in FIGS. 3A and 3B.

While a hard disk drive 10 may readily include more than one disk 20, more than one rotating disk surface 82, more than one read-write head 300, and more than one actuator arm 52, the basic operations of the hard disk drive remain similar. The actuator arm block 50 affects the hard disk drive as follows. The swinging of the actuator assembly 200 away from the rotating disk surface is stopped by the crash stop stub 70 on the actuator arm block, when it contacts the crash stop rubber 120.

The invention may further preferably include a flexible printed circuit bracket including the crash stop rubber. The flexible printed circuit bracket may further preferably include an air block for directing the air flow from one or more rotating disks away from at least one head gimbal assembly attached to the actuator arm block.

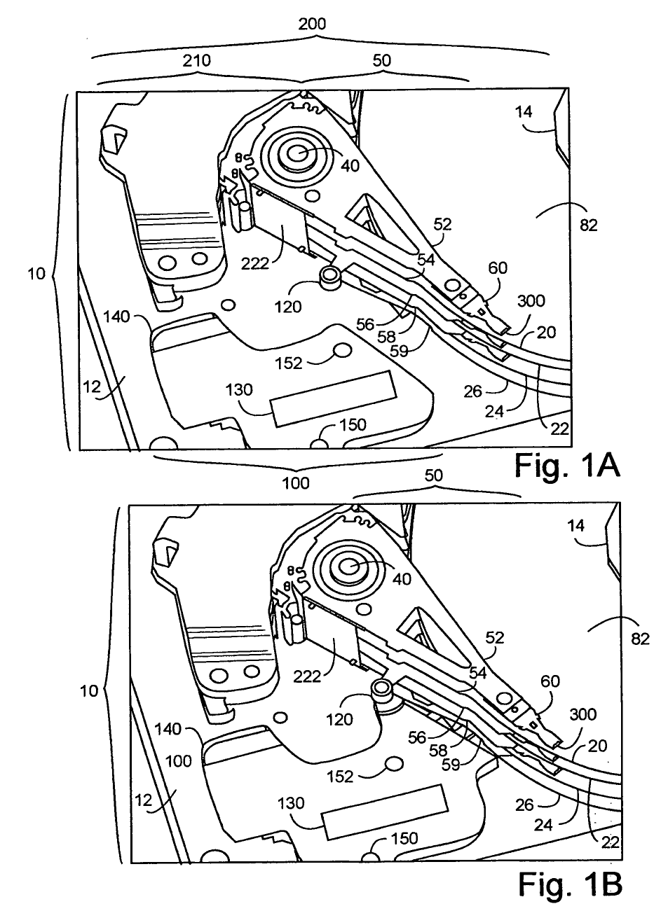

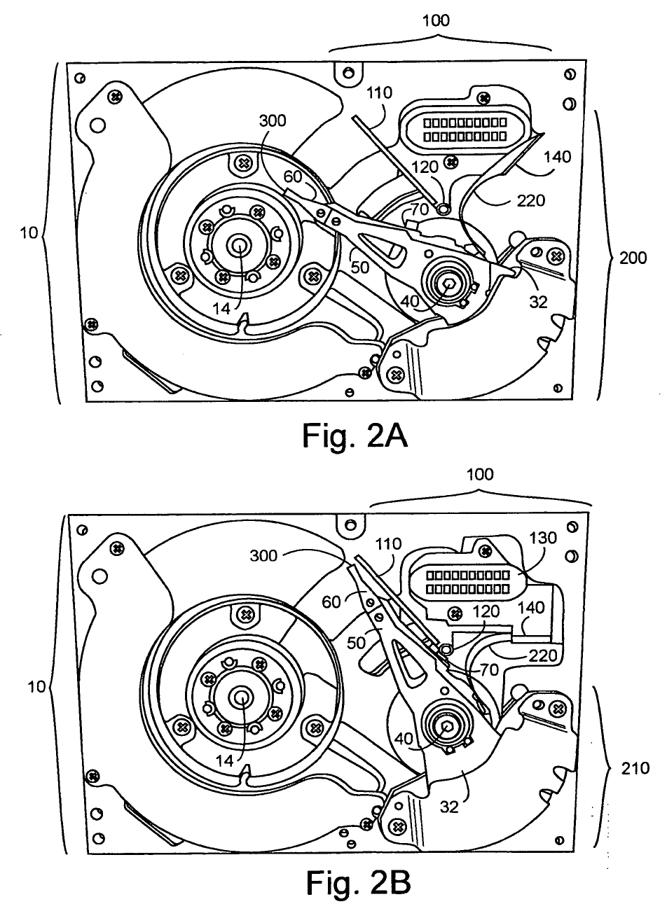

A flexible printed circuit bracket 100 may not include the crash stop rubber 120 as shown in FIG. 1A. It may preferably include the crash stop rubber as shown in FIGS. 1B to 2B. The flexible printed circuit bracket may further preferably include an air block 110 for directing the air flow from at least one rotating disk 20 away from at least one head gimbal assembly 60 attached to the actuator arm block. A rotating disk surface 82 is created when the disk 20 rotates about the disk spindle 14. The airflow from the disk is directed away from at least one head gimbal assembly 60 by the air block of the flexible printed circuit bracket. This reduced air flow acts to reduce positional variations of the read-write head 300.

The flexible printed circuit bracket 100 may preferably contain both the crash stop rubber 120 and the air block 110. As used herein, the air block will refer to a thin, essentially rigid shield rising perpendicular from the flexible printed circuit bracket near the actuator assembly 200, that acts to direct airflow away from at least one head gimbal assembly 60 of the hard disk drive 10. The crash stop rubber is preferably situated on the windward side of the air block, as shown in FIGS. 2A and 2B, forming an airfoil that further directs the airflow away from the head gimbal assembly, when used in the hard disk drive. The air block is shown with two parallel sides, but certain alternative embodiments may form the air foil from non-parallel sides.

The invention includes the actuator arm block coupled with a voice coil, an actuator assembly and hard disk drive including the actuator arm block, as well as methods of manufacturing them. The actuator arm block coupled with the voice coil, the actuator assembly and the hard disk drive are also products of the invention's manufacturing methods.

The invention's actuator arm block 50 is preferably coupled with a voice coil 32 when used in an actuator assembly 200 and/or hard disk drive 10. The invention includes making the actuator arm block coupled with the voice coil. The actuator arm block is preferably made from a metal. The metal is often preferred to be a form of aluminum, which is extruded and machined to make the actuator arm block. Coupling the actuator arm block and the voice coil may preferably include gluing the actuator arm block to the voice coil. The actuator arm block coupled with the voice coil is a product of the invention's manufacturing methods.

Referring to the invention's actuator assembly 200 and hard disk drive 10, they preferably include the actuator arm block 50. The making of the actuator assembly and the hard disk drive preferably includes mounting the actuator arm block via its actuator pivot 40 to the disk base 12 and attaching the crash stop rubber 120. The crash stop rubber preferably may be included in the flexible printed circuit bracket 100. Attaching the crash stop rubber may include using at least one of the means for attaching 150. The crash stop stub 70 in the middle actuator arm 56, is aligned to contact the crash stop rubber when the actuator assembly swings away from the disk spindle 14. The actuator assembly and hard disk drive are products of the invention's manufacturing methods.

Referring to the actuator assembly 200, it may alternatively include a flexible printed circuit 220 electrically and mechanically coupled with a preamplifier site 222 on the actuator arm block 50, and may also be coupled with the flexible printed circuit bracket 100. Making the actuator assembly includes the following steps: mounting the flexible printed circuit bracket 100 and the flexible printed circuit, and coupling the flexible printed circuit to the actuator arm block.

Referring further to the operation of the hard disk drive 10, the actuator assembly 200 swings about the actuator pivot 40. During normal access operations, the actuator assembly pivots through the actuator pivot by the interaction between the voice coil 32 coupled to the actuator arm block 50 and the fixed magnets of the voice coil motor 210. A disk controller drives at least one electrical signal provided to the voice coil. As the electrical signal varies over time, the actuator assembly moves, varying the position of the read-write head 300, that is located in at least one head gimbal assembly 60 attached to an actuator arm 52 of the actuator arm block.

Further referring to the flexible printed circuit bracket 100 as shown in FIGS. 1B to 2B, it typically includes a ribbon cable connector site 130, a flex mounting interface 140 and at least one means for attaching 150 the flexible printed circuit bracket to a disk base 12. It is often preferred that the means for attaching be a screw hole aligned to a threaded screw hole in the disk base. The flexible printed circuit bracket may preferably include a second means for attaching 152 the flexible printed circuit bracket to the disk base. The flex mounting interface often faces the actuator assembly 200 near the voice coil motor 210. Preferably, the crash stop rubber 120 and/or the air block 110 are rigidly aligned to the ribbon cable connector site and to the flex mounting interface. In certain embodiments, the ribbon cable connector site may directly couple to an embedded control printed circuit board without the use of an intervening ribbon cable. The flexible printed circuit bracket is preferably made of a non-outgasing plastic.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. An actuator arm block for use in an actuator assembly within a hard disk drive, comprising: a crash stop stub on a middle actuator arm to contact a crash stop rubber in said hard disk drive.

2. Said actuator arm block of claim 1, consisting of said middle actuator arm with a means for coupling with a voice coil.

3. Said actuator arm block of claim 1, further comprising a first actuator arm.

4. Said actuator assembly of claim 1, comprising said actuator arm block coupled with a voice coil.

5. Said actuator assembly of claim 4, further comprising:
said actuator block coupled to a flexible printed circuit, further coupled to a flexible printed circuit bracket; wherein said flexible printed circuit bracket includes: a crash stop rubber aligned for coupling to said crash stop stub to stop said actuator assembly from swinging away from a rotating disk surface in said hard disk drive.

6. Said actuator assembly of claim 5, wherein said flexible printed circuit bracket further comprising: said crash stop rubber rigidly aligned to a ribbon cable connector site and to a flex mounting interface.

7. A method of making said actuator assembly of claim 1, comprising the steps of:
mounting said actuator arm block via an actuator pivot to a disk base; and
attaching said crash stop rubber to said disk base.

8. The method of claim 7, comprising the steps of:
coupling a flexible printed circuit to said actuator arm block and to a flexible printed circuit bracket.

9. The method of claim 8, wherein said flexible printed circuit bracket includes: said crash stop rubber aligned for coupling to said crash stop stub to stop said actuator assembly from swinging away from a rotating disk surface in said hard disk drive.

10. Said actuator assembly as a product of the process of claim 7.

11. Said hard disk drive of claim 1, comprising a crash stop rubber aligned for contacting to said crash stop stub in said actuator arm block to stop said actuator assembly from swinging away from a rotating disk surface.

12. Said hard disk drive of claim 11, further comprising:
said actuator block coupled to a flexible printed circuit, said flexible printed circuit coupled to a flexible printed circuit bracket including said crash stop rubber.

13. Said hard disk drive of claim 11, further comprising:
at least one disk able to rotate, creating at least one rotating disk surface, the air flow from said disk directed away from a head gimbal assembly near said rotating disk surface by an air block included the flexible printed circuit bracket, said head gimbal assembly coupled to said actuator arm block.
